(19) United States
(12) Patent Application Publication
(10) Pub. No.: US 2016/0312881 A1
(43) Pub. Date: Oct. 27, 2016

(54) Shift Knob Assembly

(71) Applicants: Tristan Paul Morse, Portland, OR (US); Kellen Hoyt Russell, Portland, OR (US)

(72) Inventors: Tristan Paul Morse, Portland, OR (US); Kellen Hoyt Russell, Portland, OR (US)

(21) Appl. No.: 15/139,804

(22) Filed: Apr. 27, 2016

Related U.S. Application Data
(60) Provisional application No. 62/153,476, filed on Apr. 27, 2015.

(51) Int. Cl. F16H 59/02

(52) U.S. Cl. CPC F16H 59/0278

(57) ABSTRACT

An improved shift knob is described having a shift knob capable of coupling to a shaft with a detent; a cap with a multiplicity of coupling screws; a knob with internal holes that can mate with the detent and an interior tubular section; and a stopping sleeve interposed between the shaft and the interior tubular section.

### CROSS REFERENCE TO RELATED APPLICATIONS

The present application claims priority of the Provisional Patent Application 62/153,476 filed on Apr. 27, 2015, which is incorporated herein by reference.

### BACKGROUND

The present invention relates to the apparatus and method for installing an improved shift knob assembly.

Those skilled in the art will recognize the past improvements to stick shift knob assemblies. On Dec. 12, 1926, U.S. Pat. No. 1,609,724, issued to Kendall which depicts a gear shift knob that is screwed onto the lever arm. Shortly thereafter, on Apr. 23, 1929; U.S. Pat. No. 1,710,452 entitled “Gear Shift Lever Knob” was issued to Drolette; subsequently U.S. Pat. No. 3,484,808 was issued to Contero on Dec. 16, 1969. All of this prior art is relevant to the inventive subject matter described in this application.

More recently, United States Patent Publication 2003/0143021 to Whalen describes a quick attach and release mechanism for shift knobs for manual transmission BMW® automobiles.

Despite these prior art, there is still a need for an improved shift knob and the shift knob attaching mechanism that is easy to install, is lower in cost to manufacture, and does not require threading the stick shift.

### BRIEF SUMMARY OF THE INVENTION

The inventive subject matter describes an improved shift knob that is capable of coupling to a stick shift shaft having a detent, a base, a cap with a multiplicity of coupling screws, a knob with internal holes, that can mate with the detent and an interior tubular section, and a stopping sleeve interposed between the shaft and the interior tubular section.

Also the inventive subject matter describes a kit that contains the stick shift assembly. This kit would contain the base, the cap, the coupling screws, the stopping sleeve and the knob. These items would be placed in packaging, typically a small corrugated box with upgrade instructions.

Also the inventive subject matter describes the method for upgrading an OEM stick shift to the improved stick shift knob assembly.

### BRIEF DESCRIPTION OF THE DRAWINGS

FIG. 1 is a side view of the stick shift with the improved stick shift knob.

FIG. 2 is an exploded view of the improved stick shift knob.

FIG. 3 shows cut-away view of the improved stick shift knob.

FIG. 4 shows an assembled view of the improved stick shift knob.

FIG. 5 shows a kit of parts used for the improved stick shift knob

FIG. 6 shows a method of upgrading the OEM stick shift knob to the stick shift knob assembly.

### OVERVIEW OF THE REFERENCE CHARACTERS

| | |
|---|---|
| 100 | Shift Knob Assembly |
| 110 | Shaft |
| 200 | Shift Knob |
| 210 | Cap |
| 215 | Cap Screws |
| 220 | Knob |
| 225 | Stick Shift Detent |
| 230 | Stopping Sleeve |
| 235 | Detent Holes |
| 240 | Knob Base |
| 400 | Illustrative View |
| 500 | Kit of Parts |
| 600 | Method of upgrading |
| 610 | Removing the OEM knob |
| 620 | Installing the knob base |
| 630 | Inserting a stopping sleeve |
| 640 | Attaching a knob |
| 650 | Installing a knob cap |
| 660 | Securing the knob cap to the knob base with connecting screws |

### DETAILED DESCRIPTION OF THE INVENTION

In the following description, numerous specific details are set forth such as examples of specific materials, methods, components, etc. in order to provide a thorough understanding of the present inventive subject matter. It will be apparent, however, to one skilled in the art that these specific details need not be employed to practice the present invention. In other instances, well-known materials or methods have not been described in detail in order to avoid unnecessarily obscuring the present invention.

The present inventive subject matter describes an improved stick shift knob assembly and methods of installing the improved stick shift knob.

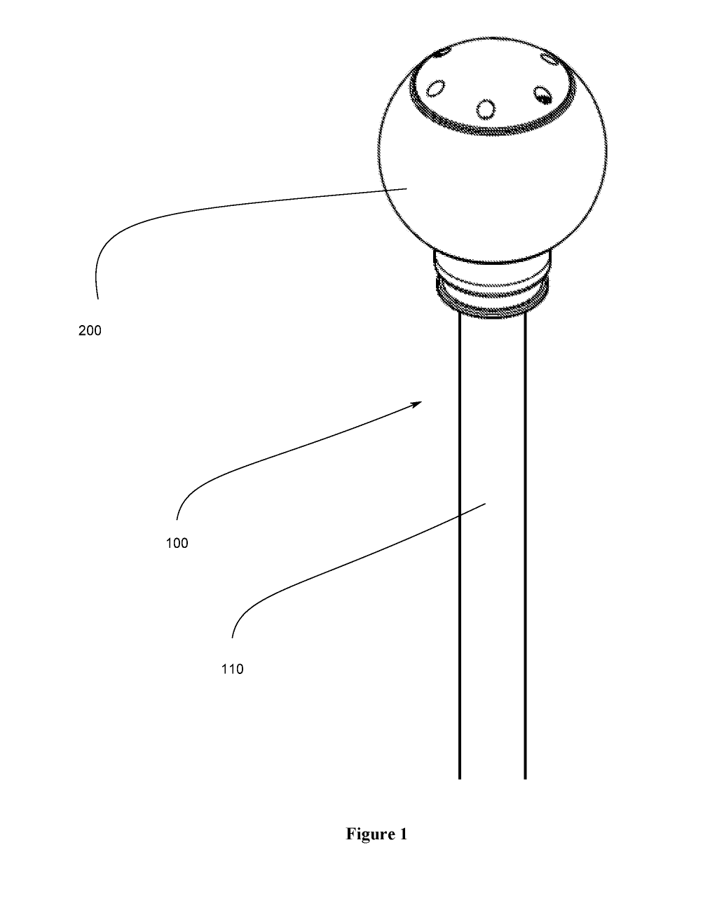

Referring to FIG. 1, the stick shift knob assembly 100 has the improved stick shift knob 200 that is mounted on the existing stick shaft 110.

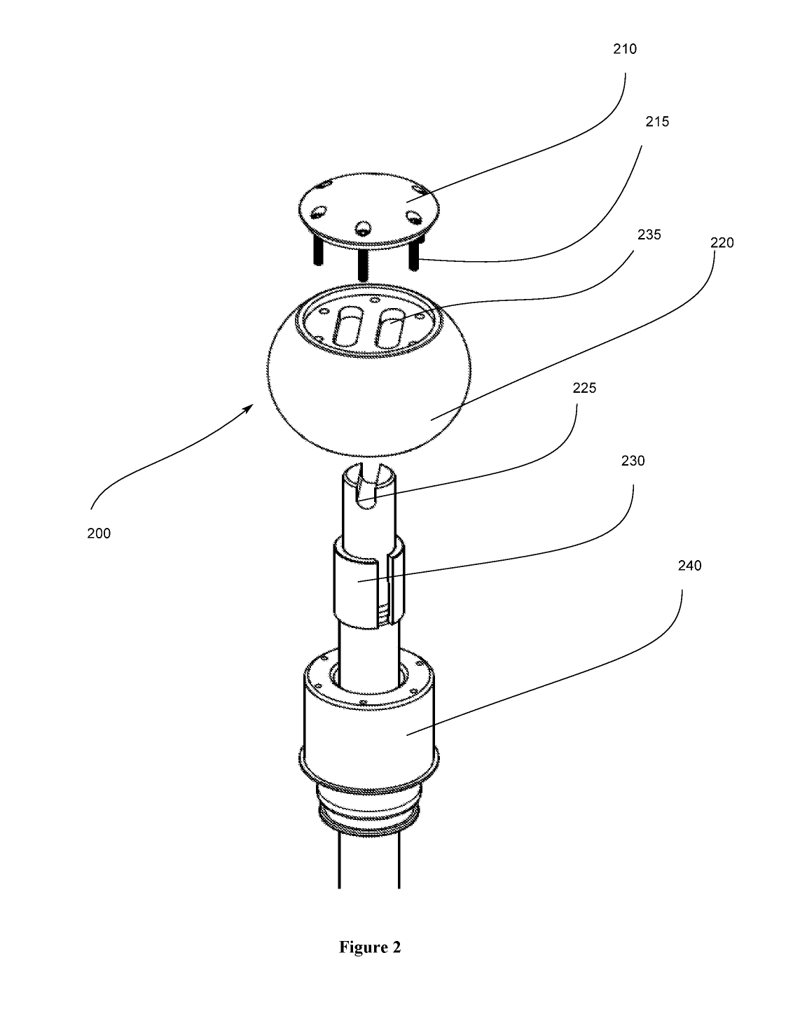

Now referring to FIG. 2 which shows an exploded view of the shift knob 200. The knob cap 210 has a number of cap screws 215 that connect through the knob 220 to the knob base 240. Internal to the knob 220 is a pair of detent holes 235 that allow the shift detent 225 to pass through. This prevents rotation of the shift knob 200 around the knob base 240. The stopping sleeve 230 helps in securing the shift knob 200 firmly over the knob base 240.

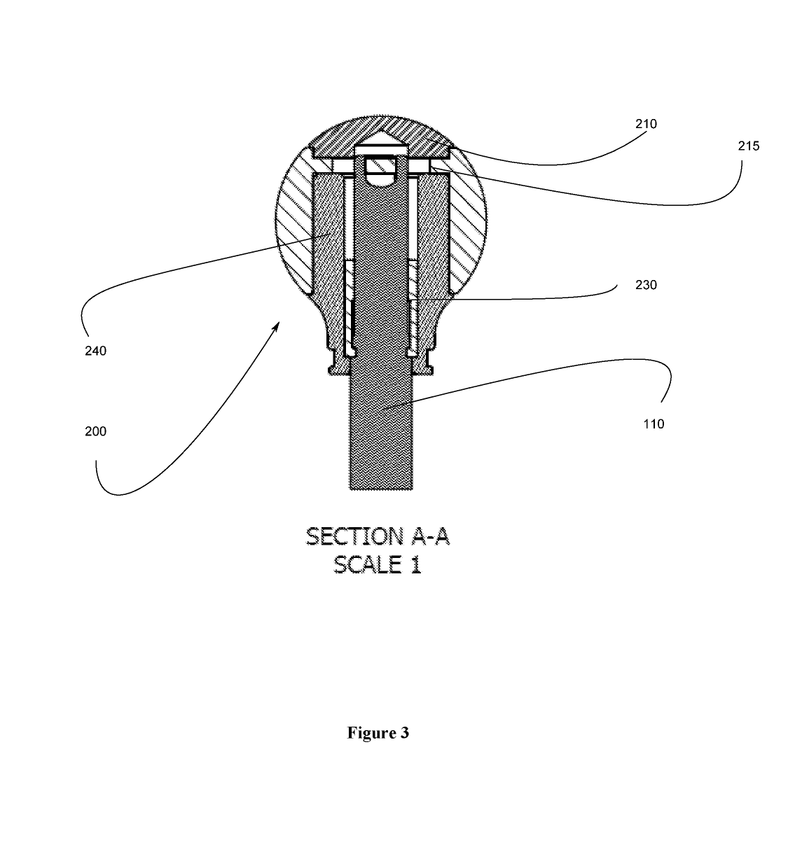

Now referring to FIG. 3 which shows a side view of the shift knob 200. The shift knob 200 is mounted on the stick shaft 110. The shift knob 200 is an assembly of the cap 210 coupled to the knob base 240 using cap screws 215. A Stopping sleeve 230 is inserted between the stick shaft 110 and knob based 240 to prevent rotation about the knob 200.

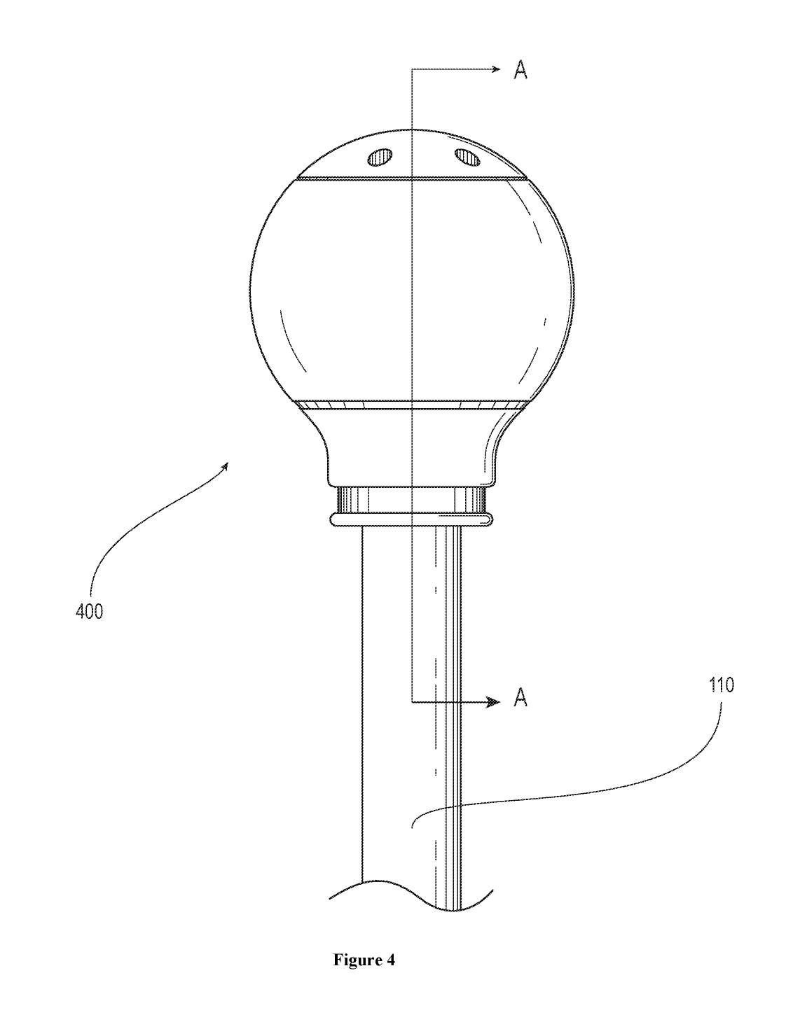

Now referring FIG. 4 which is an illustrative view 400 of the components of the stick shift knob assembly on the stick shaft 110.

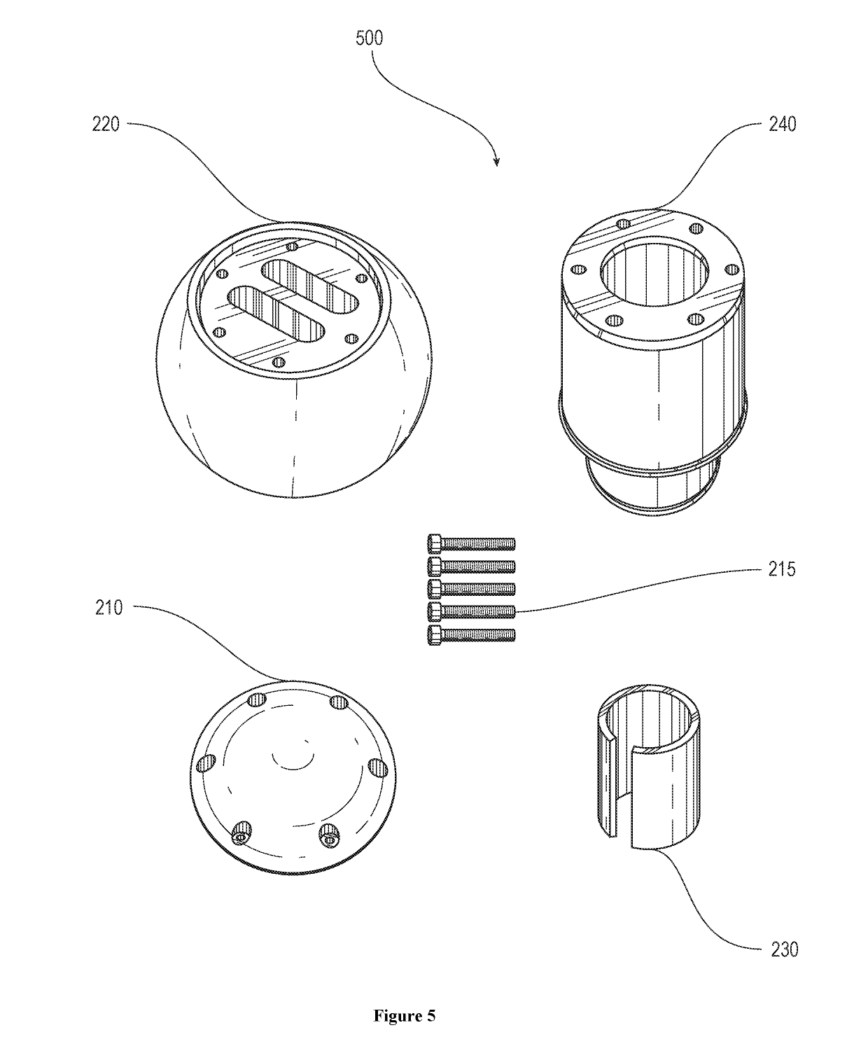

Now referring to FIG. 5 shows a kit of parts 500 used for constructing the improved stick shift knob. The kit of parts 500 would contain within a shipping box or like material: the knob base 240, the stopping sleeve 230, the knob 220, the knob cap 210, and the connecting screws 215.

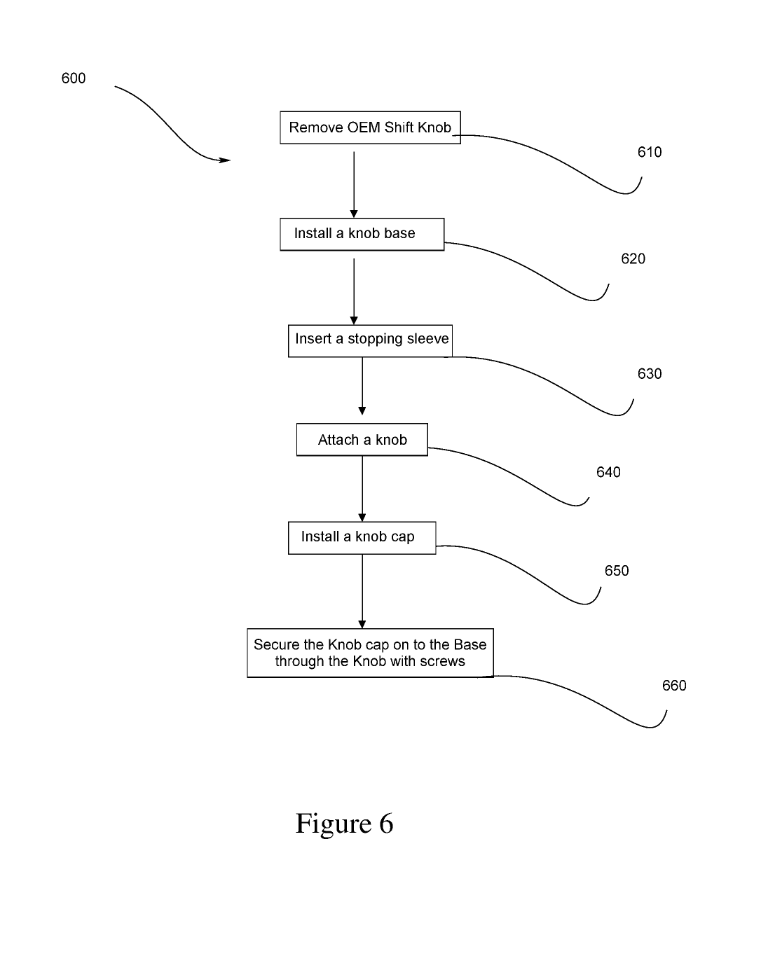

Now referring to FIG. 6 shows a method of upgrading 600 a OEM stick shift knob to an improved stick shift knob. The steps involved would be to remove an OEM Shift knob 610. This is followed by installing 620 a knob base 240, inserting 630 a stopping sleeve 230, attaching a knob 640, and then installing 650 a knob cap 210. The final step is to secure 660 a knob cap on to the base through the knob with connecting screws 215.

Although there is wide variety of materials that can be used to fabricate the various components, some preferred materials are provided as follows. In a preferred embodiment, the knob is made from a hard plastic material, typically an acetal or polyoxymethylene. The knob cap can be made of aluminum or other suitable material. The stopping sleeve can be made of any appropriate hard plastic material. The screws would be of appropriate dimensions.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

While the applicant understands that claims are not a necessary component of a provisional patent application and has not included detailed claims, the inventor reserves the right to claim, without limitation, the following subject matter.

We claim:

1. An apparatus for a shift knob comprising:
a shift knob capable of coupling to a shaft with a detent;
the shift knob further comprising:
a cap, said cap having a multiplicity of coupling screws;
a knob, said knob having a multiplicity of internal holes capable of mating with the detent and an interior tubular section;
a knob base, said knob base positioned below the ball body;
a stopping sleeve, capable of being interposed between the knob and the knob base.

2. The apparatus for a shift knob as in claim 1 wherein,
the cap is made of aluminum.

3. The apparatus for a shift knob as in claim 2 wherein the cap has multiple holes to receive multiple coupling screws.

4. The apparatus for a shift knob as in claim 2, wherein the cap has
an outer diameter that is in a range from 1.0 inches to 2.0 inches
and a height that is in a range from 0.25 inches to 1.0 inches.

5. The apparatus for a shift knob as in claim 1, wherein,
the knob is made of acetal copolymer.

6. The apparatus for a shift knob as in claim 5, wherein the knob has multiple holes to receive multiple coupling screws.

7. The apparatus for a shift knob as in claim 5, wherein the knob
has a diameter that is in a range from 2.0 inches to 3.0 inches
and a height that is in a range from 1.0 inches to 2.0 inches

8. The apparatus of the shift knob as in claim 5, wherein the knob has a pair of detent holes to couple the knob to the shaft.

9. The apparatus for a shift knob as in claim 1, wherein
the knob base is made of stainless steel.

10. The apparatus for the shift knob as in claim 9, wherein the knob base has multiple holes to receive multiple coupling screws.

11. The apparatus for a shift knob as in claim 9, wherein the knob base
has a height that is in a range from 1.0 inches to 2.0
and a diameter that is in a range from 1.0 inches to 2.0 inches.

12. The apparatus for a shift knob as in claim 1, wherein
the stopping sleeve is made of acetal copolymer.

13. The apparatus for a shift knob as in claim 11, wherein the stopping sleeve
has a height in a range from 1.0 inches to 2.0 inches,
an outer diameter in a range from 0.5 inches to 1.0 inches
and an inner diameter in a range from 0.5 inches to 1.0 inches.

14. A kit for installation of a shift knob on a shaft, the kit comprising:
a shipping box, the shipping box further comprising:
a knob base;
a stopping sleeve;
a knob;
a knob cap;
and a multiplicity of screws.

15. A method for upgrading a shift knob comprising the steps of:
removing an OEM knob;
installing a knob base;
installing a stopping sleeve;
installing a knob;
installing a knob cap;
is securing the knob cap onto the knob base through the knob with connecting screws.
